(19) United States
(12) Patent Application Publication
(10) Pub. No.: US 2007/0153776 A1
(43) Pub. Date: Jul. 5, 2007

(54) Method and apparatus for routing internet telephone calls based upon the media types and formats or CODEC capabilities of the end points or destinations

(76) Inventors: Gigo K. Joseph, Arlington Heights, IL (US); Devarajan S. Puthupparambil, Mount Prospect, IL (US)

Correspondence Address: PERRY HOFFMAN & ASSOCIATES P.C., PO BOX 1649, DEERFIELD, IL, 60015, US

(21) Appl. No.: 11/322,012

(22) Filed: Dec. 29, 2005

(51) Int. Cl. H04L 12/66

(52) U.S. Cl. 370/356

(57) ABSTRACT

In a packet-based communications network, where proxy servers guide the routing of requests and responses between destinations to aid in establishing the flow of voice or other media streams between the destinations, and where at least some destinations are assigned an IP or other network address and a telephone number or other symbolic address, a system for establishing the routing of the media streams that comprises at least one directory database associating at least some destination network addresses with symbolic addresses and, in at least some cases, also with media type and format or CODEC capability information combined with at least one proxy server connecting to the directory database. Programs within the proxy server cause the proxy server, in response to receiving a given request which contains a symbolic address, to route the given received request to a destination whose network address the directory database associates with the symbolic address contained in the given received request. In the case where the directory database associates two or more network addresses with the symbolic address contained in such a given received request, the proxy server routes the given received request to the one of the two or more network addresses which the directory database associates with media type and format or CODEC capability information most compatible with the media type and format or CODEC capabilities of the destination that sent out the given received request.

### BACKGROUND OF THE INVENTION

1. Field of the Invention

The present invention relates generally to digital telephony over packet networks such as the Internet and, more generally, to the use of control streams containing requests and responses to establish the routing of media streams (audio, FAX, video, multimedia, data, etc.) flowing between destinations or end points on such packet-based networks. In particular, the present invention relates to ways of automatically routing telephone calls and other types of media streams which reflect and take into account the media types and formats or CODEC capabilities of the destinations or end points.

2. Description of the Prior Art

FIGS. 1, 2, and 5 disclose the operation of an illustrative, conventional Internet telephone system that operates in compliance with the Session Initiation Protocol, or SIP, set forth in a “Request for Comments” or RFC 3261 published by The Internet Society in June of 2002 (superseding an earlier RFC 2543 published in March of 1999). This conventional system is fully described in the introductory paragraphs of the “DETAILED DESCRIPTION OF THE EMBODIMENTS” which is presented below. Briefly summarized, FIGS. 1 and 2 disclose two conventional Internet telephones A 102 and B 106 interconnected by the Internet 104. When first placed into operation, these two Internet telephones 102 and 106 register with one or more proxy servers, such as the illustrative SIP proxy server 108. A database is maintained within a directory server 110 (FIG. 5). The directory server 110 records (among other things) the telephone number and Internet address of each registered telephone in the database within the directory server. (These three figures set forth a very simple configuration for illustrative purposes only—they do not depict a typical and much more complicated configuration having many telephones, many proxy servers and other media servers, and including interconnections to the conventional domestic PSTN telephone system as well as multiple IP provider networks.)

The lower half of FIGS. 1 and 2 present a timeline of events where time advances downward, as is indicated by the arrow 134. This timeline illustrates the time sequence of the messages (which the SIP protocol labels “requests” and “responses”) that are sent back and forth across the Internet to set up a call and also the datagrams that are typically used to convey voice information back and forth between the telephones.

When a party uses the telephone A 102 to place a call to the telephone B 106, FIG. 1 illustrates that a SIP INVITE request (shown at 140 and at 142) is relayed from the telephone A 102 to the telephone B 106 through one or more proxy servers 108. The telephone B 106 responds with a SIP USER BUSY response 146. The proxy server 108 responds to this by forwarding the same INVITE request (shown at 150) to a voice mail server 130. The voice mail server 130 responds with an OK response (shown at 152 and at 154) which the proxy server 108 relays back to the telephone A 102.

A two-way voice conversation is then conveyed back and forth between the telephone A 102 and the voice mail server 130 across the Internet 104 by means of RTP datagrams 158 formulated in accordance with another RFC 3550 (“RTP: A Transport Protocol for Real-Time Applications:” The Internet Society, January 1996-replacing the earlier RFC 1889). These datagrams are transmitted using the Internet's UDP/IP protocol (The TCP/IP protocol can also be used both for voice communication and for sending “requests” and “responses.”)

Internet telephones that connect standard analog telephones to the Internet must digitize the incoming analog voice signals received from the telephone's microphone. This process is called “pulse code modulation,” or “PCM.” The voltage level of the incoming analog signal is typically sampled 8,000 times each second, and then each sample is represented by a computed data byte. The magnitude of the data byte is adjusted by an encoding algorithm to be roughly the logarithm of the sampled analog voltage level, normally in accordance with one of two standard protocols—an A-law protocol (used in Europe) or a mu-law protocol (used in the United States and in Japan)—defined by an ITU standard named G.711. This adjustment process is called “coding” or “encoding.” The data bits are typically sent out over the Internet encapsulated in time-stamped RTP datagrams.

Incoming Internet data bytes also typically arrive packed in time-stamped RTP datagrams. The bytes in these datagrams are transformed roughly anti-logarithmically, in accordance with the G.711 protocol, back into numbers which are then used to adjust the level of an outgoing analog voice signal 8,000 times each second, and this voice signal is sent out to the analog telephone's speaker. This transformation process is called “decoding.”

The computer program code which “encodes” the signals sent out over the Internet and “decodes” the signals received back from the Internet is called a “CODEC” (an acronym formed by combining “CODing” with “DECoding”—also used to describe the hardware “CODECS” found in conventional PSTN digital central office switches and used to perform analog-to-digital and digital-to-analog conversions on incoming and outgoing analog telephone signals). In the field of Internet telephony, the term “media” is used as a name for the coded voice information. The phrases “media type” and “media format” describe the particular way in which voice (or, in other cases, video or multimedia) information has been encoded for transmission or storage. In FIG. 1, the telephone A 102 uses a G.711 CODEC to generate encoded voice signals whose media type or media format is also then said to be in accord with the G.711 RFC.

A typical conventional voice mail server, such as the voice mail server 130, is an ordinary server—it has no digital signal processor (DSP) associated with it. Lacking the computational power of a DSP or of an equivalent high-speed ASIC, such a voice mail server is unable to encode or decode (in real time) a compressed voice media signal, since the execution of such complex encoding and decoding typically involves performing many thousands of discrete cosine or fast Fourier transformations or the like upon the voice information. The voice mail server 130 thus only supports the reception and transmission in real time of uncompressed voice messages formatted using one of the two protocols found in the G.711 standard. Since voice signals compliant with the G.711 media format are not compressed, a G.711-encoded signal must present 64,000 data bits per second (8,000 samples per second multiplied by 8 data bits per sample), and the transmission of such a signal across the Internet encoded as RTP datagrams, when the complete set of IP headers is taken into account, can only be accomplished by sending between 100,000 and 120,000 data bits per second (or thereabouts) across the Internet.

In many situations, this may tax the channel capacity. For example, many cable or DSL connections have a limited upstream bandwidth that may only support one Internet telephone call at this data rate. To provide support for two or more telephone lines over such a connection it is advantageous to select a different media format and CODEC that compresses the information. As just one example, if an upstream DSL connection supports only one voice channel encoded using the G.711 protocol, that same upstream DSL connection may be able to support up to five voice channels encoded in a compressed manner using one of the G.729 protocols (8,000 to 11,800 data bits per second plus IP header information) or up to ten voice channels encoded in a compressed manner using one of the G.723.1 protocols (5,300 to 6,300 data bits per second plus IP header information).

In FIG. 2, which in most other respects repeats the sequence of events shown in FIG. 1, the SIP telephone 102 is shown this time compressing voice information using a CODEC compliant with one of the several G.729 protocols. The INVITE requests 240, 242, and 250 sent across the Internet thus all specify that the receiving voice telephone or voice mail server must also have a G.729 CODEC implementing this same protocol. (This CODEC specification is contained in what is called the “message-body” portion of a request or response, formatted as a “Session Description Protocol” or SDP, in accordance with an RFC 2327—The Internet Society, April 1998—updated by an RFC 2543—The Internet Society, June 2002).

Since the voice mail server 130 supports only a G.711 CODEC, the server 130 cannot possibly accept (in real time) a compressed incoming call originating from a telephone that is using a G.729 CODEC. Accordingly, in FIG. 2, in response to the INVITE request 250, the voice mail server 130 responds with a NOT ACCEPTABLE or N.A. response 252 and 254 which includes an UNSUPPORTED MEDIA TYPE message. The call does not go through to the voice mail server 130, and no voice mail message is recorded.

The present invention seeks to overcome this difficulty and also to overcome similar problems, such as that of automatically routing incoming FAX calls to a separate FAX machine. More generally, the present invention seeks to enable the automatic routing of incoming calls or messages in accordance with the media type and format or CODEC that has been selected by the caller.

### SUMMARY OF THE INVENTION

Briefly described, the present invention, in one embodiment, can be realized in a packet-based communications network, where proxy servers guide the routing of requests and responses between destinations to aid in establishing the flow of voice or other media streams between the destinations, and where at least some destinations are assigned an IP or other network address and a telephone number or other symbolic address. The invention is a system for establishing the routing of the media streams that comprises at least one directory database associating at least some destination network addresses with symbolic addresses and, in at least some cases, also with media type and format or CODEC capability information. It further comprises at least one proxy server connecting to the directory database. Programs within the proxy server cause the proxy server, in response to receiving from a destination (or end point) a given request which contains a symbolic address, to route the given received request to a destination whose network address the directory database associates with the symbolic address contained in the given received request. In the case where the directory database associates two or more network addresses with the symbolic address contained in such a given received request, the proxy server routes the given received request to the one of the two or more network addresses which the directory database associates with media type and format or CODEC capability information most compatible with the media type and format or CODEC capabilities of the destination that sent out the given received request.

### BRIEF DESCRIPTION OF THE DRAWINGS

FIG. 1 presents a block diagram of a conventional Internet telephony system with voice mail in its upper half and a timing diagram illustrating the flow of requests and responses between the elements of the telephony system in its lower half, illustrating the normal operation of a conventional Internet telephony system with voice mail.

FIG. 2 also presents a block diagram of a conventional Internet telephony system with voice mail in its upper half and a timing diagram illustrating the flow of requests and responses between the elements of the telephony system in its lower half, illustrating the operation of such a conventional Internet telephony voice mail system when the CODEC used by a calling telephone is incompatible with the CODEC used by the voice mail system.

FIG. 3 presents a block diagram of an Internet telephony system with voice mail in its upper half and a timing diagram illustrating the flow of requests and responses between the elements of the telephony system in its lower half, illustrating an embodiment of the present invention that automatically selects a voice mail server whose CODEC is compatible with that of the calling telephone.

FIG. 4 presents a block diagram of an Internet telephony system with FAX support in its upper half and a timing diagram illustrating the flow of requests and responses between the elements of the telephony system in its lower half, illustrating an embodiment of the present invention that automatically selects between a voice telephone and a FAX terminal depending upon the CODEC specified by the calling telephone or machine.

FIG. 5 presents a representation of an illustrative conventional database of the type to be found in a conventional directory server that is associated with one or more proxy servers in an Internet telephone system.

FIG. 6 presents a representation of an illustrative directory server database modified in accordance with an embodiment of the present invention.

FIG. 7 presents a representation of an illustrative directory server modified to suit the requirements of the embodiments of the present invention illustrated in FIGS. 3 and 4.

### DETAILED DESCRIPTION OF THE EMBODIMENTS

### Introduction and Background

The description presented below focuses upon application of the invention to an Internet telephone system that conveys voice signals. The invention is also applicable to any type of packet-based communications network where control streams containing requests and responses establish the routing of any types of media or multimedia stream (audio, video, FAX, picture phone, data, music, etc.) between destinations assigned IP or other Internet or intranet addresses and also assigned telephone numbers or other like symbolic addresses, such as e-mail addresses, personnel numbers, physical addresses, or even names. The invention is described in the context of a single packet-based communications network, but it could also include many such networks linked by conventional digital telephone systems and central office switches.

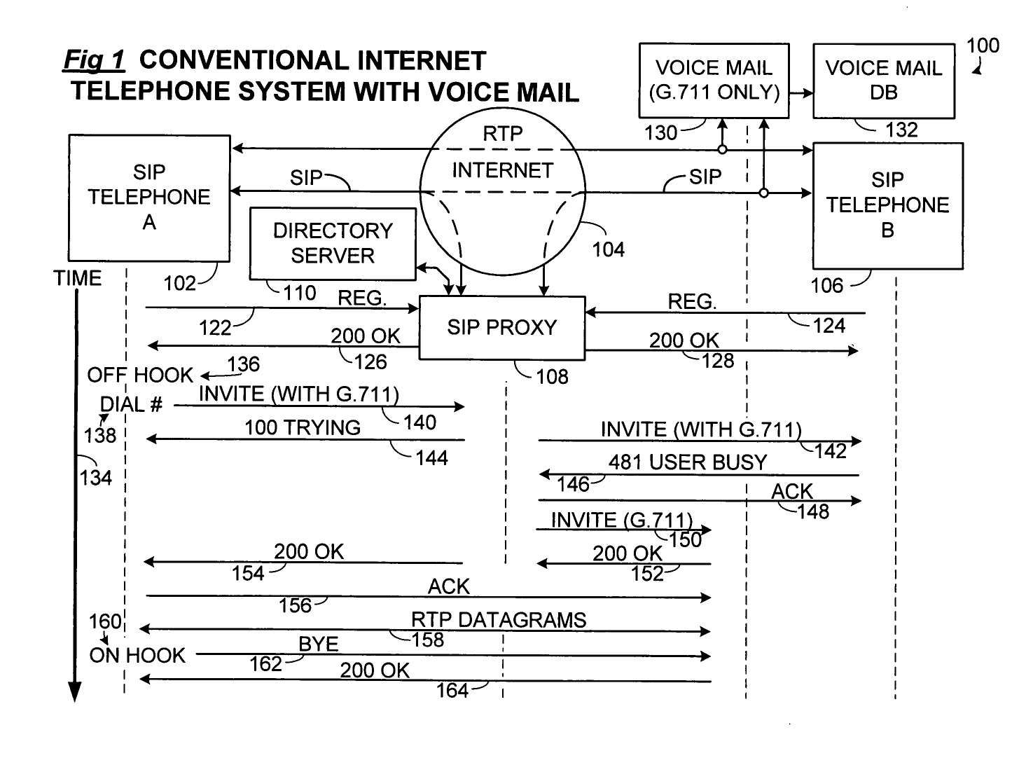

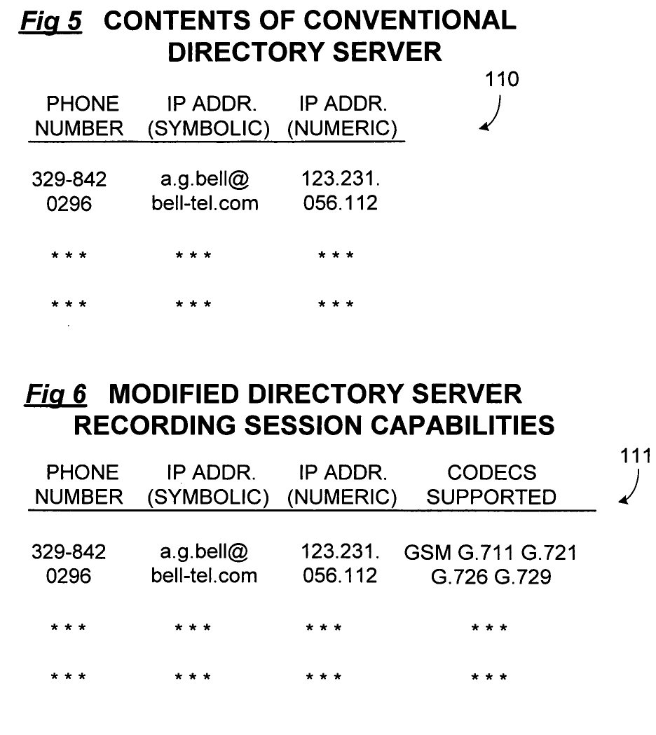

A conventional Internet telephone system 100 is illustrated in FIG. 1 of the drawings. The system illustrated in FIG. 1 is implemented in accordance with the Session Initiation Protocol (“SIP”), set forth in Request for Comments or RFC 3261 (The Internet Society, June of 2002), which supersedes and replaces an earlier RFC 2543 published in March of 1999. Hereinafter, this will be referred to as the SIP RFC. This protocol, briefly described, sets forth a definition of a dialogue whereby a first SIP telephone A 102 may find and then arrange to communicate and exchange voice information over the Internet 104 with a second SIP telephone B 106 with the assistance of one or more intermediary Internet servers which may be called SIP proxy servers. A typical SIP proxy server 108 is shown in FIG. 1 connected for communication with a conventional directory server 110 (FIG. 5) containing telephone numbers and associating each telephone number (for example, “329-842 0296”) with a symbolic IP address (such as “a.g.bell@bell-tel.com”) and with a corresponding numeric IP address (such as “123.231.056.112”) as is illustrated in FIG. 5. The SIP proxy server 108 may itself serve as the directory server 110.

The SIP telephones A and B may take many forms. They may be implemented as software installed on a personal, laptop, or pocket computer having a headset or speaker and microphone, where the computer is connected by wires or wirelessly to the Internet. They may be stand-alone Internet-ready telephones, such as Cisco's 7902G IP phone, connected either by an Ethernet cable or by a Wi-Fi (IEEE 802.11b, -c, or -g) or WiMAX (IEEE 802.16a) wireless connection to a LAN that connects to the Internet. Some may also be conventional telephones connected to the Internet by means of some form of adapter (for example, a LAN router having several conventional telephone ports such as the Linksys Model WRT54GP2). The illustrated SIP telephones A 102 and B 106 may be any of these, or they may take other conventional forms. Since Internet telephones and the numerous ways in which they may be interconnected to the Internet by wired and wireless LANs and by other means are well known, the details of such telephones and interconnections are not shown.

In accordance with the SIP RFC, Internet telephone calls are established by the SIP telephone A 102 entering into what is called a “SIP transaction” with one or more proxy servers 108 and another SIP telephone 106. A “SIP transaction” begins with a SIP request that may be forwarded or relayed ahead by one or more proxy servers; and it ends with one or more SIP responses, all of which are defined in the SIP RFC. In the discussion which follows, requests and their responses are identified simply by their formal SIP RFC names or abbreviations of those names, and further details about any request or response may be found in-the SIP RFC. Examples of SIP requests referred to below and in the drawings are: “REGISTER,” “INVITE,” “ACK,” and “BYE.” Responses are frequently preceded by a numeric value, such that the SIP responses as set forth in the above two RFCs are consistent with (and in some cases extensions of) the HTTP 1.1 hypertext transfer protocol responses which are defined in a separate RFC 2626 (The Internet Society, June 1999) which obsoletes and replaces an earlier RFC 2068. Examples of SIP responses referred to below and in the drawings are “100 TRYING,” “200 OK,” “415 UNSUPPORTED MEDIA TYPE,” “481 USER BUSY,” and “606 NOT ACCEPTABLE.”

Every SIP request and SIP response is formulated in printable ASCII lines of text terminated by a blank line (a line containing “<CR><LF>”). A “message-body” is frequently appended to requests and responses (see the SIP RFC, Section 7). In particular, the “INVITE” and “ACK” requests and the “200 OK” response normally include a “message-body” that is called a “session description.” A “session description message-body” provides the party receiving the request or response with enough information to join into a communication session in a compatible way. Among other things, the session description enumerates the media types and formats or CODEC capabilities that the caller or callee generating the request or response is equipped with. All session descriptions are formulated in accordance with a “Session Description Protocol,” or SDP, which is set forth in RFC 2327 (The Internet Society, April 1998) updated by RFC 3264 (The Internet Society, June 2002). In the discussion which follows, when a request or response specifies the media types and formats or CODEC capabilities that a host wishes to use, that specification is added to the request or response as a “session description message-body” formulated in accordance with the RFC 2327. (The “380 ALTERNATIVE SERVICE” response also normally includes a message body that is described at a later point below.)

The session description also advises the caller or the callee of the “port” to which the other party is to direct voice information datagrams (every computer has UDP ports that range from port 0 to port 65,535 many of which are assigned to other tasks). Typically today, voice information packets are sent as Internet Datagrams formulated in accordance with the Internet's Uniform Datagram Protocol, or UDP (see RFC 768, August 1980), which establishes communication between what are called “UDP ports” on the two communicating hosts. The protocol used for this host-to-host voice communication is the RTP protocol which may be found in RFC 3550 (Internet Society, July 2003—replacing RFC 1889 dated January 1996).

With reference now to FIG. 1, the SIP telephones A 102 and B 106 are assumed to have registered with the SIP proxy server 108 by sending SIP REGISTER requests 122 and 124 to the SIP proxy server 108 to cause information concerning their telephone numbers and Internet addresses to be registered in the directory server 110 database. The SIP proxy server 108 responds with a 200 OK response 126 and 128, in accordance with the SIP protocol. The SIP telephone B is also associated with a voice mail server 130 and voice mail database 132, and the SIP proxy server 108 is programmed to route incoming voice calls destined for the SIP telephone B 106 to the voice mail server 130 whenever the SIP telephone B 106 reports that it is busy.

A typical call progression sequence is illustrated in the lower part of FIG. 1, with time increasing down the page of this drawing, as is indicated at 134.

A user takes the SIP telephone A 102 off-hook 136 and directs it to dial 138 the number of the SIP telephone B 106. In response to this user command, the SIP telephone A generates an INVITE request 140, indicating it can encode speech for transmission in accordance with the media type and format or CODEC G.711. This INVITE request 140 is formulated in accordance with the SIP protocol and also contains “session information” specifying that the telephone A 102 is capable of using a G.711 CODEC and, possibly, other CODECs as well.

The SIP proxy server 108 responds with an initial 100 TRYING response 144 (to stop the telephone A 102 from sending the request 140 repeatedly). The SIP proxy server 108 looks up the number of the SIP telephone B 106 in its directory server 110, obtains the Internet address of the telephone B 106, and forwards the INVITE request 142 on to the SIP telephone B 106. The telephone B 106 responds with a 481 USER BUSY response 146, indicating that the telephone B is busy and cannot respond. The SIP proxy server 108 acknowledges this response by sending an acknowledgment or ACK request 148 to the SIP telephone B 106.

The SIP proxy server 108 then determines from its directory server 110 that a voice mail 130 is associated with the SIP telephone B 106, and accordingly the SIP proxy server 108 forwards the INVITE request (at 150) on to the voice mail server 130 together with its included indication that the telephone A 102 uses the G.711 PCM protocol. The voice mail 130 is able to communicate using G.711, so it responds with a 200 OK response 152, indicating the G.711 PCM protocol is acceptable. The SIP proxy server 108 receives this 200 OK response 152 and relays it on (at 154) to the SIP telephone A 102. This 200 OK response 152 advises the SIP telephone A 102 to communicate with the voice mail server 130 using RTP datagrams addressed to a UDP port that is designated in the SDP portion of the SIP 200 OK response 152 and 154. The telephone A 102 responds by sending an ACK request 156 directly to the voice mail server 130 (bypassing any proxy servers, including the server 108)

The RTP-formulated datagrams 158 then flow back and forth directly between the SIP telephone A 102 and the voice mail server 130 as the user A produces a voice mail message and directs the voice mail server 130 to record it in the vice mail database 132. When the user of the SIP telephone 102 places the telephone “on hook” at 160, a BYE request 162 is sent directly from SIP telephone A 102 to the voice mail server 130, which responds with a 200 OK reply 164. This completes the call progression.

The voice mail server 130 is a conventional server that does not include a digital signal processor or DSP and thus does not have sufficient computational power to decompress a compressed incoming voice message in real time. It sends and receives RTP datagrams containing voice signals encoded using the G.711 non-compressed protocol only, sending and receiving 64,000 bits of voice information each second (plus packet header information). The voice mail server 130 cannot handle, for example, the I.T.U. compressed voice information protocols G.723 and G.729, protocols that reduce the amount of voice data that must be transmitted each second down substantially, as was explained above.

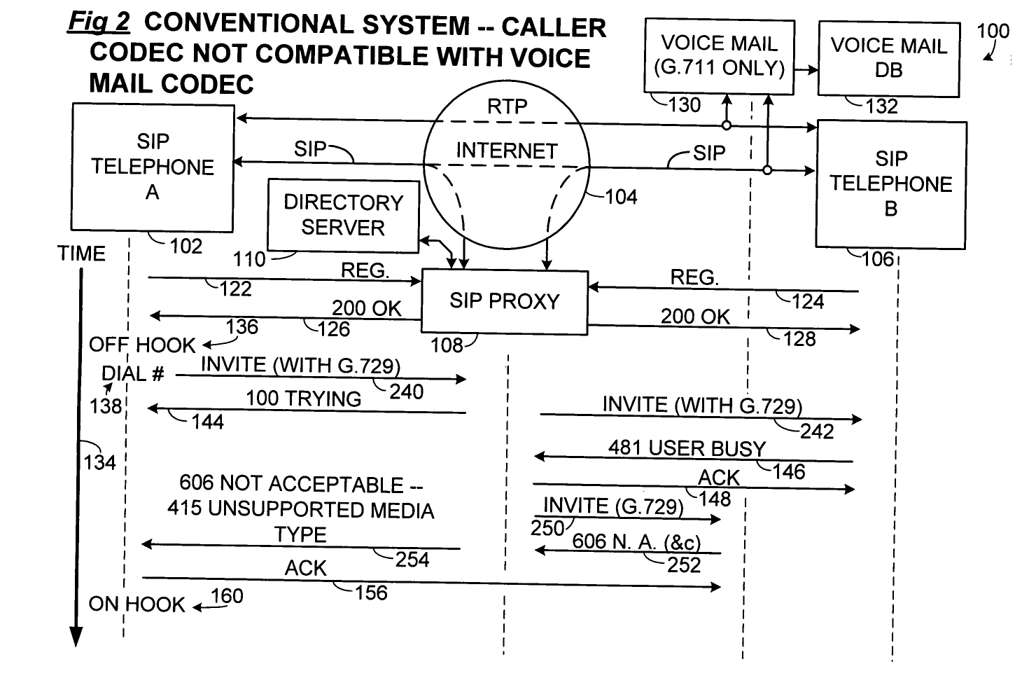

In FIG. 2, the call transaction is almost the same as that depicted in FIG. 1, with the one exception that this time the SIP telephone A sends out an INVITE request 240 which contains, in its SDP portion, an indication that it uses and supports use of the G.729 compressed audio protocol (and possibly other protocols) but does not support the uncompressed G.711 protocol. This INVITE request, at 242, is forwarded to the SIP telephone B which responds with the same 481 USER BUSY response 146. The SIP proxy server 108 then sends the same INVITE request (at 350) specifying the G.729 protocol to the voice mail server 130. Since the server 130 cannot accept and decode voice messages encoded using the G.729 protocol, the voice mail server 130 responds to this request by sending back 606 NOT ACCEPTABLE and 415 UNSUPPORTED MEDIA TYPE responses 252, which the SIP proxy server 108 relays back to the SIP telephone A (at 254). The SIP telephone A 102 then sends an ACK request 156 to the voice mail server 130 and advises the user of the SIP telephone A 102 that the call could not be completed.

Hence, the voice mail service fails to record a message whenever an incoming call is encoded using a CODEC that performs compression and decompression and, accordingly, is a CODEC not supported by the voice mail server 130,.

Adding Additional Entries in the Directory Server Database to Enable CODEC Capability Routing of Incoming Calls

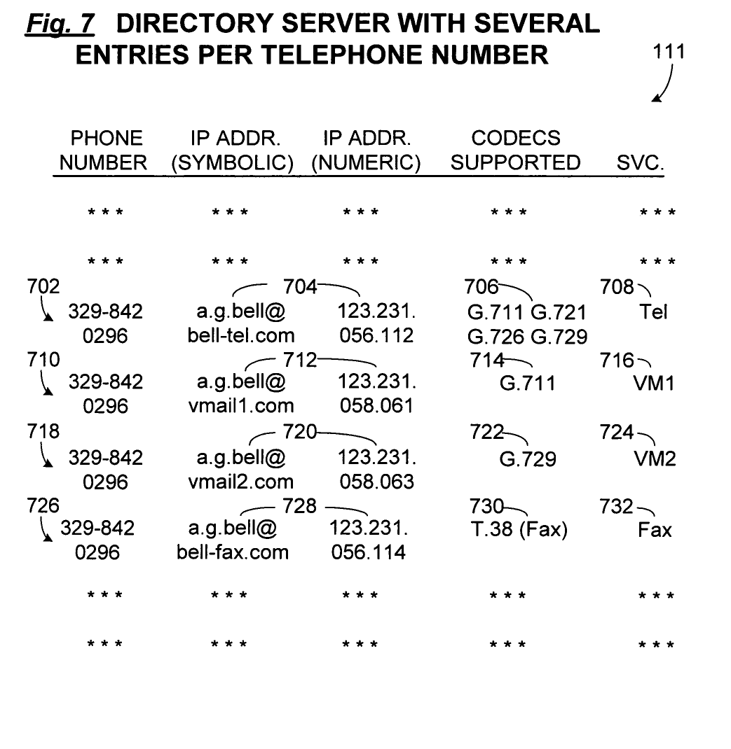

To overcome this and other similar problems, the present invention in one embodiment captures and preserves within a modified directory server 111 (see FIGS. 6 and 7) a list of the media types and formats or CODECs supported by each Internet telephone destination (“CODECs Supported”). This “CODECs Supported” information can be captured automatically whenever equipment such the two Internet telephones 102 and 106 initially register if the SIP registration requests 122 and 124 generated by these telephones include this CODEC information in a SDP encoded “message-body.” Alternatively, this information can be captured automatically from later requests or responses that are sent out by Internet telephone destinations. A system administrator can also be provided with controls allowing the administrator to add or to adjust this information. With this “CODECs Supported” information included in the directory server 111, programming within the SIP proxy server 108 may then detect a CODEC or media incompatibility between a caller and a callee before forwarding the caller's request to the callee. Call routing can then be altered in accordance with the media type and format or CODEC that a caller specifies or designates.

To provide even greater flexibility, the present invention in another embodiment, illustrated in FIG. 7, allows multiple records to be recorded within the directory server 111 for the same telephone number. As an example, and with reference to FIG. 7, four records are shown for the single telephone number (329) 842-0296 that is associated with the SIP telephone B 106.

The first record 702 contains the Internet address 704 of the SIP telephone B 106 itself (identified as a “TEL” at 708 in the record 702). The record 702 also indicates at 706 that the SIP telephone B 106 contains four CODECS which can encode and decode audio media formatted using any of the following four protocols: G.711, G.721, G.726, and G.729.

The second record 710 contains the Internet address 712 of the first voice mail server 130 (identified as “VM1” at 716 in the record 710). The record 702 also indicates at 714 that the first voice mail server 130 contains only one CODEC which can encode and decode audio media formatted using the G.711 protocol.

The third record 718 contains the Internet address 720 of a second voice mail server 302 (identified as “VM2” at 724 in the record 718). The record 718 indicates at 722 that the second voice mail server 302 contains only one CODEC which can encode and decode audio media using the G.729 compressed protocol.

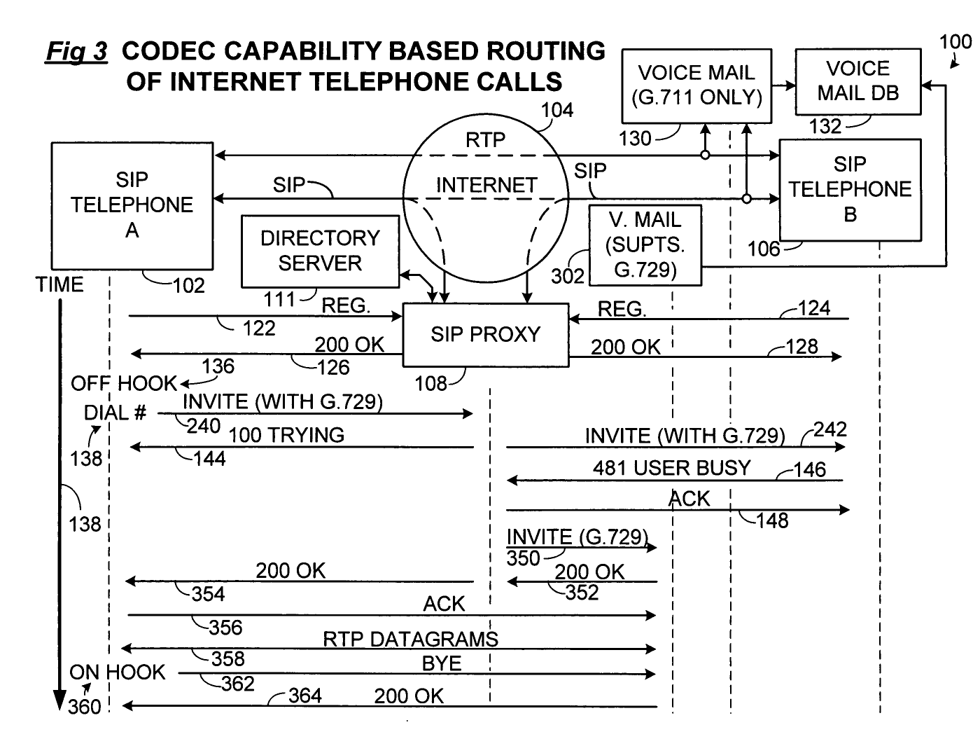

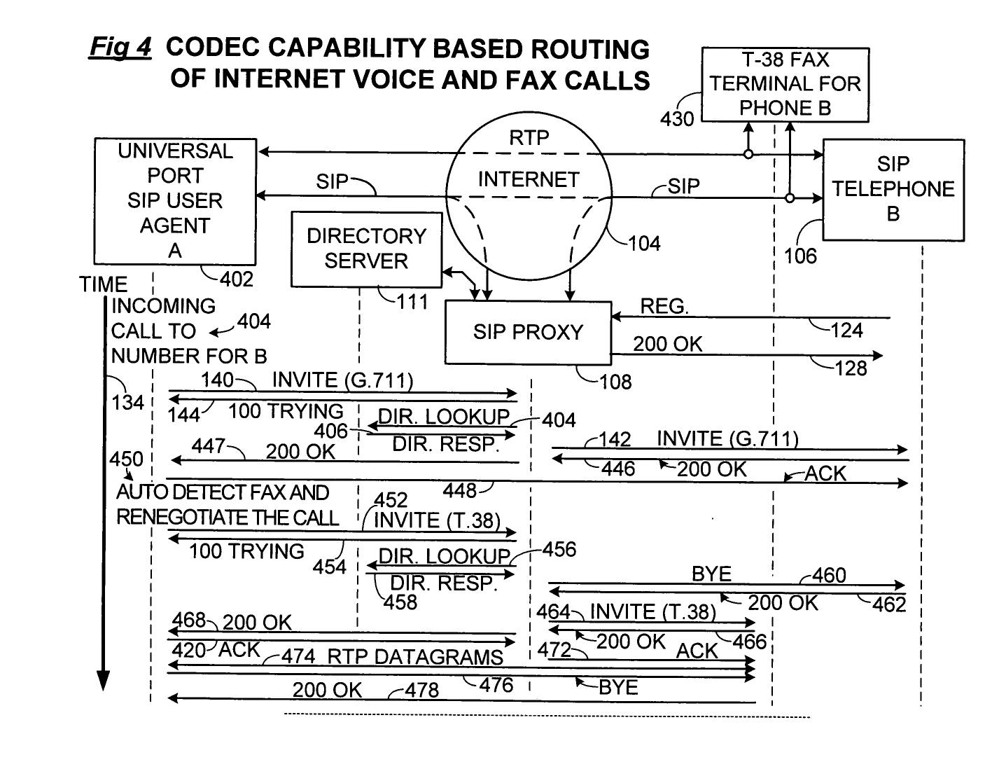

The fourth record 726 contains the Internet address 728 of a FAX terminal 430 (FIG. 3) that is to receive all faxes addressed to the telephone B 106 (FIG. 4). The record 726 indicates at 730 that the FAX terminal 430 contains only one FAX protocol CODEC which can code and decode incoming media using a T.38 FAX protocol. (This is discussed below.)

Still another embodiment (not shown in the drawings) can implement the switching or routing in dependence upon media types and formats or CODEC capabilities that are not found in the directory server 111. For example, the “380 ALTERNATIVE SERVICE” response can include a message body that describes an alternative service or services available for a given telephone number. The alternative service or services can be services supporting different media types or formats or CODEC capabilities, thus enabling a SIP proxy server to perform CODEC-capability-based routing based upon this message body information. This message body information can also be used to update the directory server 111 information in appropriate cases.

Once provision is made whereby the directory server 111 contains the desired media and format or CODEC information, as illustrated in FIG. 7, or alternatively when “380 ALTERNATIVE SERVICE” responses are arranged to provide the desired media type and format or CODEC information to the SIP proxy server 108, software may then be included within the SIP proxy server 108 that can perform call routing partly based upon the media types and formats or CODEC capabilities that accompany each given request (normally contained within the “message-body” portion of an SIP request).

FIG. 3 illustrates a first embodiment of the invention where the routing of a voice mail call to an appropriate voice mail server compatible with the media types and formats or CODEC capabilities of the calling equipment is accomplished automatically. FIG. 4 illustrates a second embodiment of the invention where special calls, such as FAX calls, are automatically routed to Internet destinations different from those utilized for voice calls based upon the media types and formats or CODEC capabilities that accompany the incoming FAX or other special call request.

CODEC Capability Based Routing of Calls Between Several Voice Mail Systems

With reference to FIG. 3, the same sequence of events previously presented in FIGS. 1 and 2 is again shown, where the telephone A 102 attempts to establish communication over the Internet with the telephone B 106 but finds the telephone B to be busy. This time, however, the directory server 111 (FIG. 7) can be utilized. It lists the CODECs supported by the various callers and callees. By examining the two voice mail records 710 and 718 which both contain the telephone number of the telephone B 106, the proxy server 108 is able to determine that the entry 718 contains the “CODECs Supported” entry 722 that has the value “G.729,” which matches the CODEC specified by the telephone A 102 in its INVITE requests 240 and 242. Accordingly, the proxy server 108 forwards the INVITE request 350 not to the incompatible voice mail server 130 but to the voice mail server 302 which can handle voice media encoded in accordance with G.729. (Within the second voice mail server 302, the G.729 decoding/decompression and encoding/compression is typically performed by some form of hardware DSP or ASIC.) The server 302 is shown placing voice mail into the same voice mail database 132 that is used by the G.711 voice mail server 130.

In FIG. 3, the call progression proceeds just as it did in FIG. 2 down through the ACK request 148 step, and that portion of the discussion of FIG. 2 presented above is incorporated by reference at this point. After the SIP proxy server 108 receives the 481 USER BUSY response 146 and generates the ACK request 148, the SIP proxy server 108 is programmed in this embodiment to check the directory server 111 (FIG. 7), examining all of the voice mail records (in this case those marked “VM1” 716 and “VM2” 724) that contain the callee's telephone number “329-842-0296.” Two such records 710 and 718 are found: the record 710, which specifies a G.711 CODEC at 714; and the record 718, which specifies a G.729 CODEC at 722. The SIP proxy server 108 checks the “message-body” information appended to the original INVITE request 240 and discovers that the call originating telephone A 102 this time is using a G.729 CODEC and is unable to use a G.711 CODEC. Accordingly, the SIP proxy server 108 forwards the INVITE request 350 not to the G.711 voice mail server 130 but rather to the G.729 voice mail server 302, thus routing the call in accordance with the CODEC capabilities of the caller and of the two voice mail servers. The voice mail server 302 responds with a 200 OK response 352 which the SIP proxy server 108 forwards back to the telephone A 102. The telephone A 102 then sends an ACK request 356 directly to the G.729 voice mail server 302 (bypassing the SIP proxy server 108) and then initiates voice communication with the chosen voice mail server 302 by means of RTP datagrams 358 sent back and forth as was described above. After the caller has left a voice message, the caller places the telephone A 102 back on hook 360, and this causes the telephone A 102 to send out a BYE request 362 in response to which the voice mail server 302 sends back a 200 OK response 364, thus terminating the voice mail call.

CODEC Capability Based Routing of Incoming Voice and Fax Calls

FIG. 4 illustrates how CODEC capability call routing can be used in another application—distinguishing incoming FAX calls, and routing them to different equipment without requiring the use of a second telephone number. In FIG. 4, instead of a telephone A, there is a universal port SIP user agent A 402, which may include a telephone, a FAX machine, and quite possibly other appliances, such as appliances for generating e-mails or instant messaging (typed or verbal). For the purposes of FIG. 4, the user agent A includes both a telephone and also a FAX machine.

Initially, an incoming call is placed to the number for the telephone B at step 404. An INVITE request 140 specifying use of the CODEC G.711 is sent out to the proxy server 108. The proxy server 108, after returning a 100 TRYING response 144 to the user agent A 402, looks up the number (directory lookup step 404) in its directory server 111 and initially finds the record 702 (FIG. 4) containing the telephone number of the telephone B 106 and also containing the CODEC protocol G.711 (at 706). This directory response (406 in FIG. 4) enables the proxy server to send the INVITE request (at 142) to the telephone B 106, which responds with a 200 OK response 446 that is forwarded (at 447) to the user agent A 402. The agent A 402 then replies with an ACK request (at 448).

At this point, a regular telephone conversation may or may not commence. At some point, NOW OR LATER, the user AT THE AGENT at 402 places documents into the FAX facility or commands his or her computer to send out a FAX to the telephone B.

The connection is already established, but since the protocol is about to change, the user agent A 402 auto-detects the FAX generation process and initiates a renegotiation of the call transaction at step 450. A new INVITE request is sent to the proxy server 108, and this time its “message body” specifies that the media encoding is TO BE the FAX protocol T-38. This is a digital protocol for representing FAX information which may be in compressed format, where the compression is a form of run-length encoding.

The proxy server, again after sending back the 100 TRYING response 454, performs another directory lookup 456 to the directory server 111. This time, the directory response 458 indicates a record 726 (FIG. 7) was found that contains the telephone number of the telephone B 106, the FAX protocol 730, and the Internet address 728 of the FAX terminal 430 for the telephone B 106.

Accordingly, the proxy server 108 forwards the INVITE request (at 464) to the FAX terminal 430, specifying the protocol T.38 in its “message body,” and receives back a 200 OK response 466 which the server 108 promptly forwards (at 468) to the user agent A 402. The user agent A 402 then sends an ACK 420 to the sip proxy server 108, which sends the ACK 472 to the FAX terminal 430, and then transmission of the FAX commences by means of the RTP datagrams 474 formulated as described above but in accordance with the T-38 FAX protocol. When the FAX has been sent, the user agent A 402 sends a BYE request to the FAX terminal 430 and receives back a 200 OK response 478.

In one embodiment, a FAX call and a voice call may continue on in parallel, each terminating separately. In FIG. 4, as drawn, the proxy server 108 terminates the voice call by sending a BYE request to the telephone B 106 which sends back a 200 OK response 462; and then the telephone B goes off-hook. Thus, the telephone B 106 is available for another voice call, while the FAX call remains active.

An example has been given of a directory server that contains multiple records for a single telephone number—a voice call record, several voice mail records, and a separate FAX call record—each specifying a different Internet address to which calls requiring different CODECs or involving different media encodings are to be directed. This basic technique may also be applied in other situations. For example, the following types of calls or messages can all be routed to the same telephone number but routed to different hosts, or to different ports on one or more hosts, all automatically:
Voice calls
FAX calls
Picture phone calls
Delivery of e-mail with or without attachments
Delivery of still or motion picture media
Digital delivery of documents and images

All of these and others can lend themselves to routing controlled by the CODEC selected or by the nature of the medium and its format.

In the examples presented here, the telephone number is used as the primary symbolic address or routing tool. Alternatively, e-mail addresses, home page addresses, names, or postal addresses can be used, as well as other forms of numeric identification and addressing schemes—employee numbers, organization membership numbers, etc.

While several embodiments of the invention have been described, further modifications and changes will occur to those skilled in the art. Accordingly, the claims appended to and forming a part of this specification are intended to cover all such modifications and changes as fall within the true spirit and scope of the invention.

What is claimed is:

1. In a packet-based communications network, where proxy servers guide the routing of requests and responses between destinations to aid in establishing the flow of voice or other media or multimedia streams between the destinations, and where at least some destinations are assigned an IP or other network address and a telephone number or other symbolic address, a system for establishing the routing of the media streams comprising:
at least one directory database associating at least some destination network addresses with symbolic addresses and, in at least some cases, also with media type and format or CODEC capability information;
at least one proxy server connecting to the directory database and including programs comprising
a first program that causes the proxy server, in response to receiving from a destination a given request which contains a symbolic address, to route the given received request to a destination whose network address the directory database associates with the symbolic address contained in the given received request; and
a second program, responding in at least some cases when the directory database associates two or more network addresses with the symbolic address contained in such a given received request, that causes the proxy server to route the given received request to the one of the two or more network addresses which the directory database associates with media type and format or CODEC capability information most compatible with the media type and format or CODEC capabilities associated with the destination that sent out the given received request.

2. A system in accordance with claim 1 wherein the second program determines the media type and format or CODEC capability associated with the destination that sent out a given received request by retrieving that information from the given received request.

3. A system in accordance with claim 1 wherein the second program determines the media type and format or CODEC capabilities associated with the destination that sent out a given received request by retrieving from the directory database the media type and format or CODEC capability information that is linked to the network address of the destination that sent out the given received request.

4. A system in accordance with claim 1 wherein the proxy server also includes an additional program comprising a third program that establishes in the directory database associations between network addresses of at least some destinations and their media types and formats or CODEC capabilities.

5. A system in accordance with claim 4 wherein the third program retrieves media type and CODEC capability information and network address information from at least some received requests or responses and then establishes linkages in the directory database consistent with this retrieved information.

6. In a packet-based communications network, where proxy servers guide the routing of requests and responses between destinations to aid in establishing the flow of voice or other media or multimedia streams between the destinations, and where at least some destinations are assigned an IP or other network address and a telephone number or other symbolic address, a system for establishing the routing of the media streams comprising:
at least one directory database associating at least some destination network addresses with symbolic addresses and, in at least some cases, also with media type and format or CODEC capability information;
at least one proxy server connecting to the directory database and including programs comprising:
a first program that causes the proxy server, in response to receiving from a destination a given request which contains a symbolic address, to route the given received request to a destination whose network addresses the directory database associates with the symbolic address contained in the given received request;
a second program, responding in at least some cases when the directory database associates two or more network addresses with the symbolic address contained in such a given received request, that causes the proxy server to route the given received request to the one of the two or more network addresses which the directory database associates with media type and format or CODEC capability information most compatible with the media type and format or CODEC capabilities of the destination that sent out the given received request, determining the media type and format or CODEC capability of the destination that sent out the given received request either by retrieving that information from the given received request or by retrieving from the directory database the media type and format or CODEC capability information that is linked to the network address of the destination that sent out the given received request, and
a third program that establishes in the directory database associations between network addresses of at least some destinations and their media types and formats or CODEC capabilities by retrieving media type and CODEC capability information and network address information from at least some received requests or responses and then establishing linkages in the directory database consistent with this retrieved information.

7. In a packet-based communications network, where proxy servers guide the routing of requests and responses between destinations to aid in establishing the flow of voice or other media streams between the destinations, and where at least some destinations are assigned an IP or other network address and a telephone number or other symbolic address, a system for establishing the routing of the media streams comprising:
directory database means for associating at least some destination network addresses with symbolic addresses and, in at least some cases, also with media type and format or CODEC capability information;
proxy server means connecting to the directory database and including programs comprising
first program means for receiving from a destination a given request which contains a symbolic address and for routing the given received request to a destination whose network address the directory database associates with the symbolic address contained in the given received request; and
second program means for responding, in at least some cases when the directory database associates two or more network addresses with the symbolic address contained in such a given received request, to a given received request by routing the given received request to the one of the two or more network addresses which the directory database associates with media type and format or CODEC capability information most compatible with the media type and format or CODEC capabilities of the destination that sent out the given received request.

8. A system in accordance with claim 7 wherein the second program means further comprises means for determining the media type and format or CODEC capability of the destination that sent out a given received request by retrieving that information from the given received request.

9. A system in accordance with claim 7 wherein the second program means further comprises means for determining the media type and format or CODEC capabilities of the destination that sent out a given received request by retrieving from the directory database the media type and format or CODEC capability information that is linked to the network address of the destination that sent out the given received request.

10. A system in accordance with claim 7 wherein the proxy server means further comprises third program means for establishing in the directory database associations between network addresses of at least some destinations and their media types and formats or CODEC capabilities.

11. A system in accordance with claim 10 wherein the third program means includes means for retrieving media type and CODEC capability information and network address information from at least some received requests or responses and then establishing linkages in the directory database consistent with this retrieved information.

12. A method for establishing the routing of media streams flowing between destinations in a packet-based communications network where at least some destinations are assigned an IP or other network address and a telephone number or other symbolic address and where requests and responses must be routed between the destinations to aid them in establishing the routing of media streams, said method comprising:
establishing a directory database;
entering destination network addresses into the directory database and associating at least some of the network addresses with symbolic addresses and with media type and format or CODEC capability information;
in response to receiving from a destination a given request which contains a symbolic address, routing the given received request to a destination whose network address the directory database associates with the symbolic address contained in the given received request; and
if the directory database associates two or more network addresses with the symbolic address contained in such a given received request, routing the given received request to the one of the two or more network addresses which the directory database associates with media type and format or CODEC capability information most compatible with the media type and format or CODEC capabilities of the destination that sent out the given received request.

13. The method in accordance with claim 12 which further comprises:
determining the media type and format or CODEC capability of the destination that sent out a given received request by retrieving that information from the given received request.

14. The method in accordance with claim 12 which further comprises:
determining the media type and format or CODEC capabilities of the destination that sent out a given received request by retrieving from the directory database the media type and format or CODEC capability information that is linked to the network address of the destination that sent out the given received request.

15. The method in accordance with claim 12 which further comprises:
establishing in the directory database associations between network addresses of at least some destinations and their media types and formats or CODEC capabilities.

16. The method in accordance with claim 15 which further comprises:
retrieving media type and CODEC capability information and network address information from at least some transmitted requests or responses and then establishing linkages in the directory database consistent with this retrieved information.
